(19) United States
(12) Patent Application Publication
(10) Pub. No.: US 2025/0252870 A1
(43) Pub. Date: Aug. 7, 2025

(54) APPARATUSES AND METHODS FOR PRACTICING A REDUCTION PROCEDURE FOR TREATING RADIAL HEAD SUBLUXATION

(71) Applicant: UNIVERSITY OF SOUTH FLORIDA, Tampa, FL (US)

(72) Inventors: Koundinya Kompalli, Tampa, FL (US); Corey Richard Sargent, Dunedin, FL (US); John Todaro, Tarpon Springs, FL (US); Teresa N. Gore, Palm Harbor, FL (US); Sharlene Hope Smith, Clermont, FL (US); Patricia Cecil, Clermont, FL (US)

(21) Appl. No.: 18/886,935

(22) Filed: Sep. 16, 2024

Related U.S. Application Data
(63) Continuation of application No. 16/987,759, filed on Aug. 7, 2020, now Pat. No. 12,094,360.
(60) Provisional application No. 62/883,968, filed on Aug. 7, 2019.

(51) Int. Cl. G09B 23/32

(52) U.S. Cl. CPC G09B 23/32

(57) ABSTRACT

Disclosed are various embodiments of an apparatus for practicing a reduction procedure for treating radial head subluxation. In one example, the apparatus can include a model arm can be pivotally mounted to and supported by a stand. The model arm includes an upper member that emulates an upper arm of a human, a lower member that emulates a lower arm of a human being, and a joint that pivotally connects the upper member and the lower member. A feedback mechanism can be provided within the joint of the model arm. The feedback mechanism can be configured to provide initial resistance to downward pivoting to the lower member relative to the upper member, to provide an audible and tactile pop when the procedure is successfully performed that emulates the audible and tactile pop that occurs when a human radial head pops back into place during an actual reduction procedure.

### CROSS REFERENCE TO RELATED APPLICATIONS

This application is a continuation of U.S. patent application Ser. No. 16/987,759, filed on Aug. 7, 2020, which claims the benefit of, and priority to, U.S. Provisional Patent Application No. 62/883,968 entitled “APPARATUSES AND METHODS FOR PRACTICING A REDUCTION PROSECURE FOR TREATING RADIAL HEAD SUBLUXATION” filed on Aug. 7, 2019, each of which is incorporated herein by reference in its entirety.

### BACKGROUND

Radial head subluxation, sometimes referred to as “nursemaid's elbow,” is a relatively common injury that occurs in early childhood. When this injury occurs, the radiocapitellar joint of the elbow partially dislocates such that the head of the radius (i.e., the radial head) partially slips out of position within the joint. A child suffering from this injury will often hold his or her arm against his or her body with the elbow bent and avoid moving the arm as this results in pain.

When radial head subluxation occurs, a reduction procedure must be performed to put the radial head back into position. While this procedure is one of the most common procedures performed by pediatric physicians and nurse practitioners in the early stages of their careers, such healthcare professionals typically do not have any way of practicing the procedure except by performing it on injured patients. In view of this, it can be appreciated that it would be desirable to have an apparatus that enables healthcare professionals to practice the reduction procedure for treating radial head subluxation before attempting it on human patients.

### BRIEF DESCRIPTION OF THE DRAWINGS

The present disclosure may be better understood with reference to the following figures. Matching reference numerals designate corresponding parts throughout the figures, which are not necessarily drawn to scale.

FIG. 1A is a front perspective view of an embodiment of an apparatus for practicing a reduction procedure for treating radial head subluxation.

FIG. 1B is a rear perspective view of the apparatus of FIG. 1A.

FIG. 2 is a perspective view of an embodiment of an upper member of the apparatus of FIGS. 1A and 1B.

FIG. 3 is a perspective view of an embodiment of a lower member of the apparatus of FIGS. 1A and 1B.

FIG. 4A is a first perspective view of an embodiment of a joint member of the apparatus of FIGS. 1A and 1B.

FIG. 4B is a second perspective view of the joint member of FIG. 4A.

FIG. 5 is an embodiment of an internal feedback mechanism provided within a joint of the model arm shown in FIGS. 1A and 1B.

FIG. 6A is a perspective view of the apparatus of FIGS. 1A and 1B shown in an initial orientation before the reduction procedure is practiced using the apparatus.

FIG. 6B is a perspective view of the apparatus of FIGS. 1A and 1B shown in a final orientation after the reduction procedure has been practiced using the apparatus.

FIG. 7A is a cross-sectional perspective view showing the joint of the model arm shown in FIG. 6A, illustrating an initial orientation for the joint before the reduction procedure is practiced using the apparatus.

FIG. 7B is a cross-sectional perspective view showing the joint of the model arm shown in FIG. 6B, illustrating a final orientation for the joint after the reduction procedure has been practiced using the apparatus.

### DETAILED DESCRIPTION

As described above, it would be desirable to have an apparatus that enables healthcare professionals to practice a reduction procedure for treating radial head subluxation before attempting it on human patients. Disclosed herein are examples of such apparatuses, and methods for using them. In one embodiment, an apparatus for practicing a reduction procedure comprises a stand that supports a model arm. The model arm includes an upper member that emulates a patient's upper arm and a lower member that emulates the patient's lower arm. The model arm also includes a joint at which the upper and lower members are pivotally connected to each other. Within the joint is an internal feedback mechanism that emulates the audible and tactile “pop” that occurs when the reduction procedure is performed correctly using the model arm. As the procedure can be repeatedly practiced using the apparatus, the healthcare professional can become skilled at performing the procedure before applying it to human patients.

In the following disclosure, various specific embodiments are described. It is to be understood that those embodiments are example implementations of the disclosed inventions and that alternative embodiments are possible. Such alternative embodiments include hybrid embodiments that include features from different disclosed embodiments. All such embodiments are intended to fall within the scope of this disclosure.

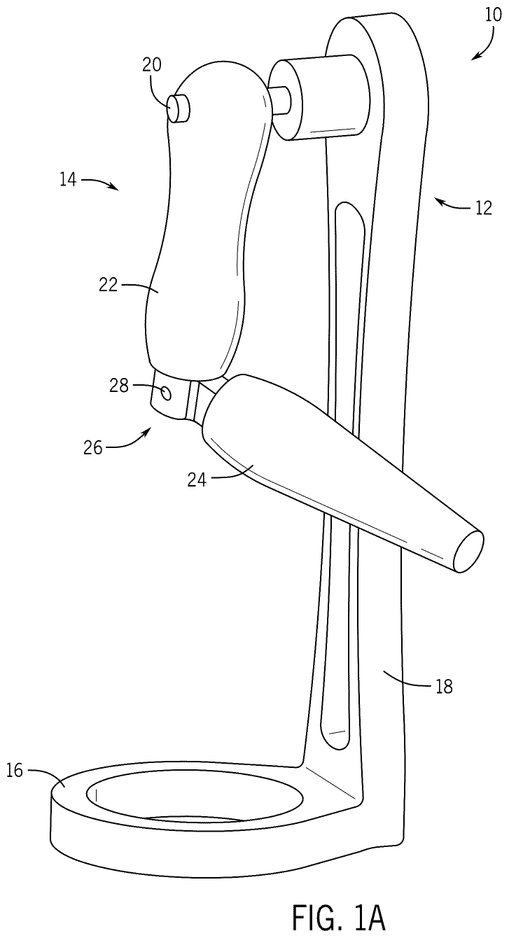

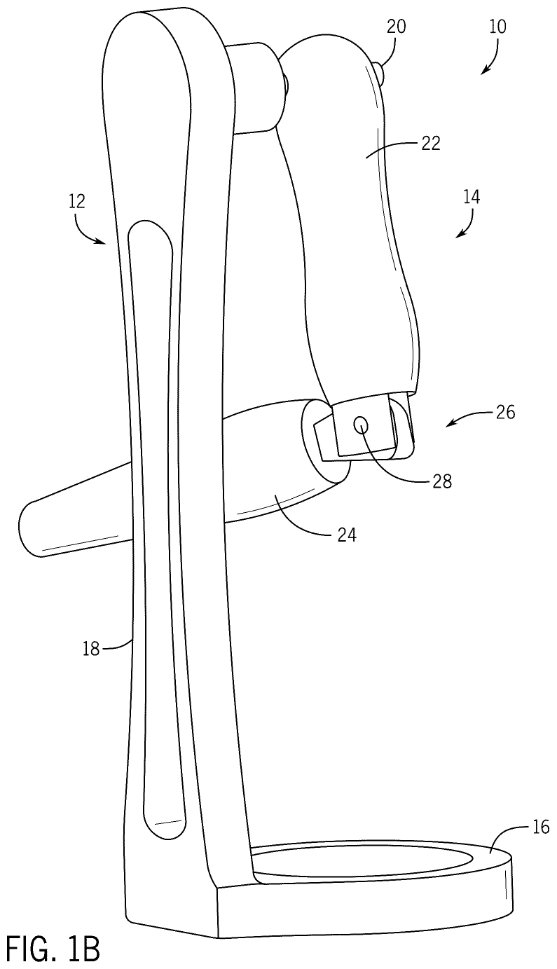

FIGS. 1A and 1B illustrate an example embodiment of an apparatus 10 for practicing a reduction procedure for treating radial head subluxation. FIG. 1A generally shows the front of the apparatus 10, while FIG. 1B generally shows the rear of the apparatus. As is apparent from these figures, the apparatus 10 generally comprises a stand 12 and a model arm 14 that is supported by the stand. The stand 12 includes a base 16 configured to rest on a work surface, such as a table top, and a vertical support 18 that extends upward from the base and supports the model arm 14. Laterally (horizontally) extending from a top end of the vertical support 18 is a shaft 20 on which the model arm 14 is pivotally mounted. With such a mounting scheme, the model arm 14 is free to pivot about the shaft 20 in a similar manner to which a human arm can be pivoted forward and backward about the shoulder joint.

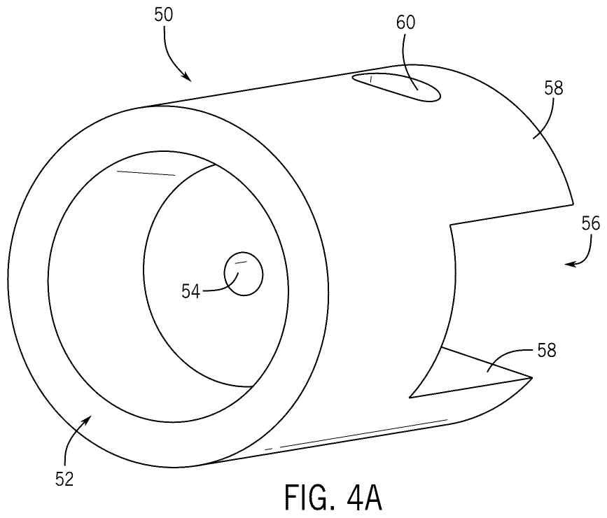

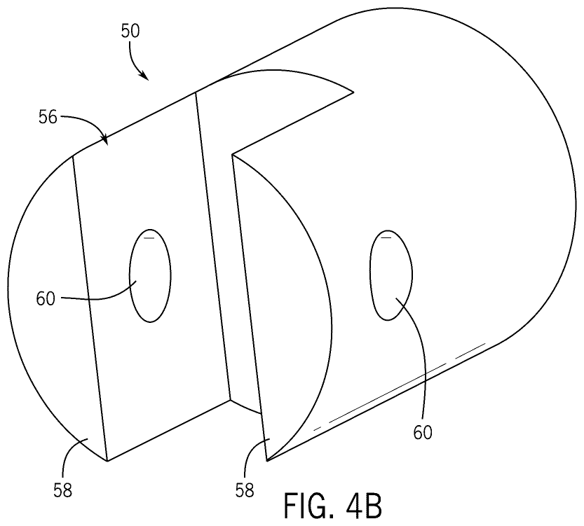

The model arm 14 generally comprises an upper member 22 that emulates the upper arm of a human being and a lower member 24 that emulates the lower arm of the human being. It is the upper member 22 that is pivotally mounted at its top end to the shaft 20. The lower member 24 is indirectly pivotally mounted at its top end to the bottom end of the upper member at a joint 26 with a joint member described below (FIGS. 4A and 4B). The lower member 24 is free to pivot about a pivot point defined by a pin 28 that extends through the joint member. As described below, the joint 26 also includes an internal feedback mechanism that provides audible and tactile feedback to the healthcare professional when the apparatus 10 is used to practice a reduction procedure.

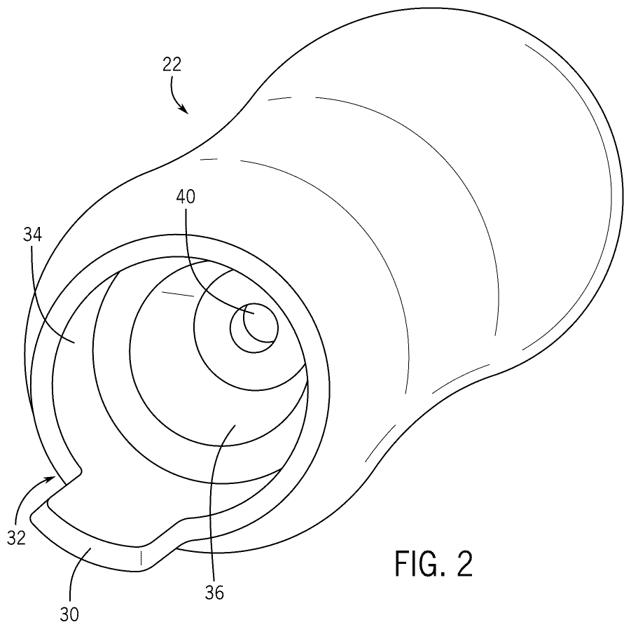

FIG. 2 shows the bottom end of the upper member 22 in greater detail. As is apparent from this figure, a tab 30 extends downward from the bottom end of the upper member 22. As described below, this tab 30 functions to provide resistance to pivoting of the lower member 24. Also apparent from FIG. 2 is a recess 32 that is formed in the bottom end of the upper member 22. As described below, this recess 32 houses part of the aforementioned internal feedback mechanism. In the illustrated embodiment, the recess 32 comprises two distinct portions that together define the recess. These portions include a distal portion 34 that is nearer to the tab 30 and a proximal portion 36 that is farther from the tab. The distal portion 34 of the recess 32 is generally cylindrical, meaning it forms a right cylinder-shaped void, while the proximal portion 36 generally frustoconical, meaning it forms a frustrum-shaped void. The wider base of the frustrum-shaped void is nearer to the tab 30 than the narrower top of the frustrum-shaped void. Also visible in FIG. 2 is a circular passage 40 formed at the proximal end (base) of the proximal portion 36 of the recess 32 that is configured to receive a shaft of the internal feedback mechanism.

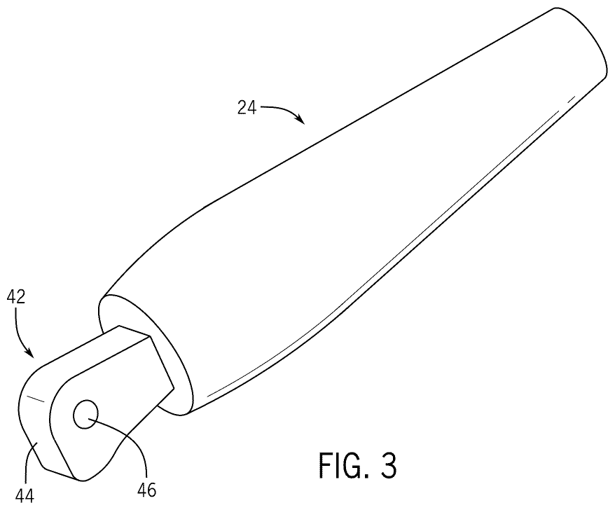

Referring next to FIG. 3, illustrated is the lower member 24. As can be appreciated from this figure, the top end of the lower member 24 comprises a cam element 42 that is configured to actuate the internal feedback mechanism and to interface with the tab 30 of the upper member 22. The cam element 42 comprises an outer cam surface 44 that is configured to interface with a joint member described below (FIGS. 4A and 4B). A transverse circular passage 46 is formed through the cam element 42 that is configured to receive and pass the pin 28 (FIGS. 1A and 1B).

FIGS. 4A and 4B show a joint member 50 that partly defines the joint 26 of the model arm 14 and that is partially received within the recess 32 of the upper member 22. The joint member 50 also supports the pin 28 and, therefore, the lower member 24. FIG. 4A illustrates a top end of the joint member 50, while FIG. 4B illustrates a bottom end of the joint member. With reference to FIG. 4A, a frustoconical recess 52 is formed in the top end of the joint member 50. Formed in the proximal end (base) of this recess 52 is a further circular passage 54 that is configured to receive the shaft of the internal feedback mechanism. With reference to FIG. 4B, a rectangular slot 56 is formed at the distal end of the joint member 50. The slot 56 is shaped and configured to receive the cam element 42 of the lower member 24 and is defined by two opposed flanges 58. Extending through each flange 58 is a circular passage 60 that is also configured to receive and pass the pin 28 (FIGS. 1A and 1B).

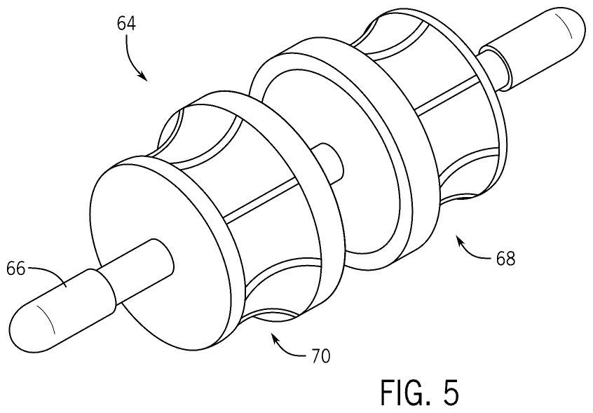

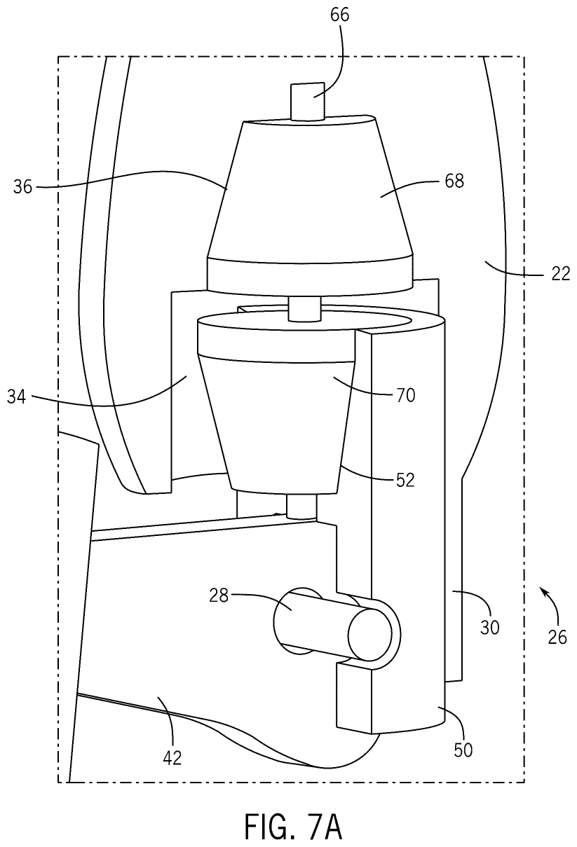

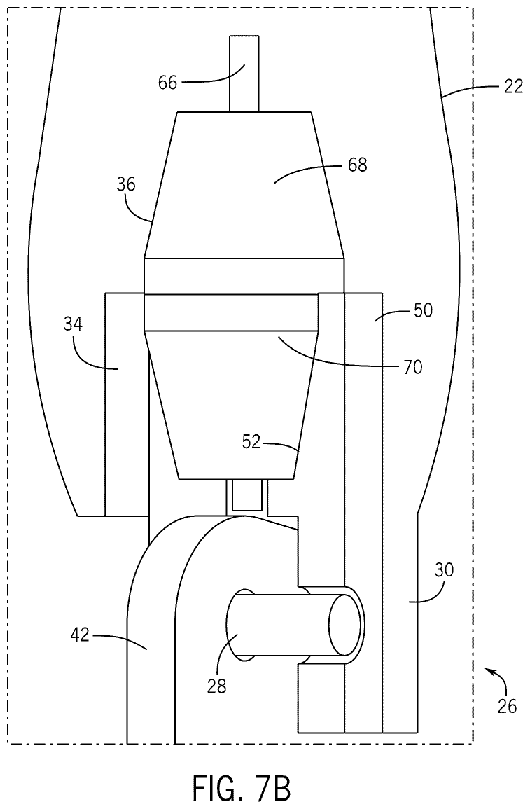

FIG. 5 shows the internal feedback mechanism 64 that has been identified multiple times above. This mechanism 64 comprises an elongated shaft 66 on which is provided first (upper) and second (lower) magnetic elements 68 and 70. These magnetic elements 68, 70 are frustoconical in shape and, therefore, are configured to be received in the recess 32 (e.g., the proximal portion 36) of the upper member 22 and the recess 52 of the lower member 24, respectively (see FIGS. 7A and 7B). As described below, the magnetic element 70 is capable of being linearly displaced along the length of the shaft 66 for the purpose of generating the audible and tactile feedback for the healthcare professional. In some embodiments, each magnetic element 68, 70 comprises an “smart” magnet designed such that the pair of magnets repel each other in a first relative angular orientation, but attract each other in a second relative angular orientation.

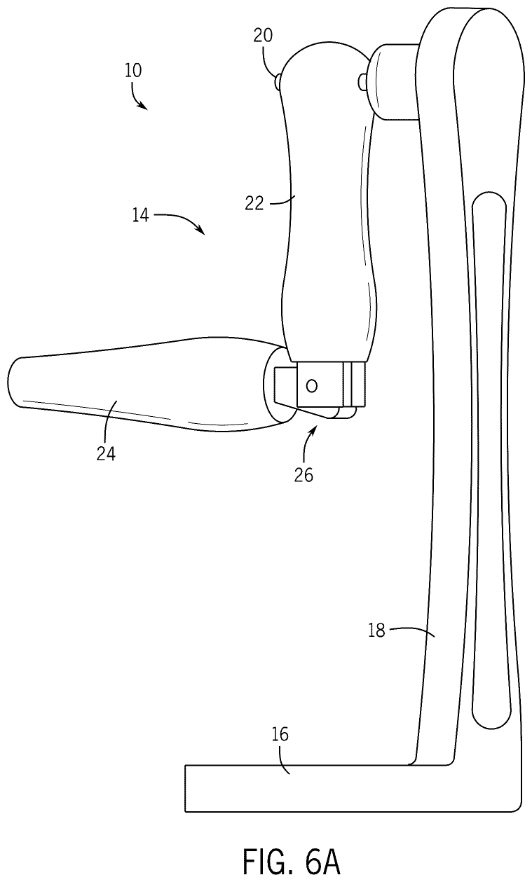

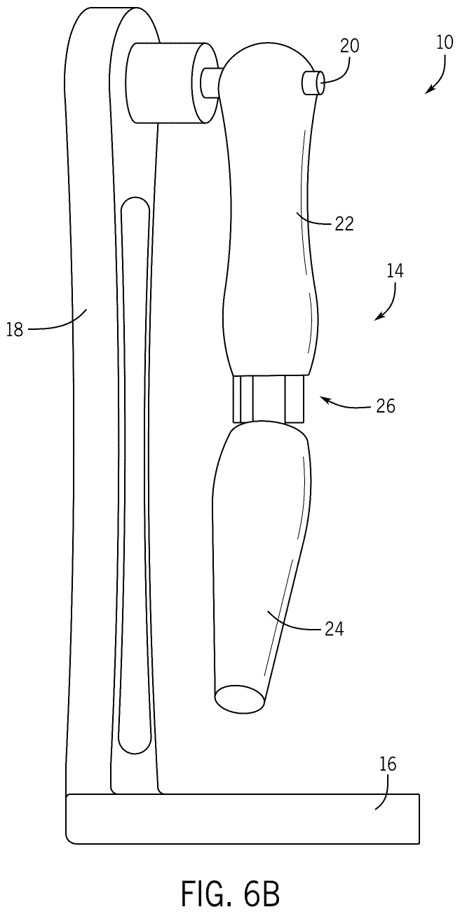

FIGS. 6A-7B illustrate operation of the apparatus 10 as well as the location, orientation, and operation of the internal feedback mechanism 64 when a reduction procedure is practiced by a healthcare professional (i.e., user) using the apparatus. Beginning with FIG. 6A, the model arm 14 is in an initial (bent) orientation that emulates how a human patient with a radial head subluxation would likely hold his or her arm. As is apparent from FIG. 6A, when the model arm 14 is in this orientation, the arm is bent such that the lower member 24 is generally perpendicular to the upper member 22 (i.e., the arm is bent at a 90° angle).

As shown in FIG. 7A, which illustrates the internal feedback mechanism 64 when the model arm 14 is the initial orientation shown in FIG. 6A, the upper magnetic element 68 of the mechanism is fully received within the proximal portion 36 of the recess 32 formed in the bottom end of the upper member 22. The top end of the shaft 66 and the upper magnetic element 68 can be fixedly secured within the proximal portion 36 of the recess 32 so that the shaft, the element, and the upper member 22 form an integrated component. In similar manner, the bottom end of the shaft 66 and the lower magnetic element 70 are fixedly secured within the recess 52 formed in the top end of the joint member 50, which is shown in cut-away view in FIG. 7A, so that the shaft, the element, and the joint member 50 also form an integrated component.

As can also be appreciated from FIG. 7A, a portion (approximately half) of the joint member 50 is received within the distal portion 34 of the recess 32 of the upper member 22. Instead of being secured within that distal portion 34 of the recess 32, however, the joint member 50 can be linearly displaced upward and downward along the portion and along the shaft 66 of the internal feedback mechanism 64. As shown in FIG. 7A, when the model arm 14 is in the initial orientation, space exists between the top of the joint member 50 and the base of the distal portion 34 of the recess 32. Similarly, space also exists between the upper and lower magnetic elements 68, 70. When the magnetic elements 68, 70 are in this spaced orientation, the magnetic elements 68, 70 repel each other due to their respective magnetizations. FIG. 7A also shows that the top end of the shaft 66 of the internal feedback mechanism 64 is received within the circular passage 40 formed at the base of the proximal portion 36 of the recess 32.

With further reference to FIG. 7A, the pin 28 passes through the circular passages 60 of the joint member 50 as well as the circular passage 46 of the cam element 42 of the lower member such that the lower member is pivotally mounted to the joint member. Due to the provision of the joint member 50 and its association with both the upper and lower members 22, 24, the lower member can be said to be “indirectly” pivotally mounted to the upper member.

In order to practice the reduction procedure, the healthcare professional cups the joint 26 of the model arm 14 in the palm of one hand to stabilize the arm and grips the lower member 24 as one would grip a baton with the other hand. The healthcare professional can then gently push or pull the lower member 24 downward while slightly twisting the lower member laterally away from the body, whether that is toward or away from the stand 12 in the user's mind. Moving the lower member 24 downward pivots the lower member about the pin 28, while twisting the lower member changes the relative angular orientation between the magnetic elements 68, 70 from the first relative angular orientation, in which they repel each other, to the second relative angular orientation, in which they attract each other. Notably, there is enough “play” within the joint 26 to facilitate such twisting (only a few degrees of twisting are needed). The tab 30 of the upper member 22 provides moderate resistance to the downward pivoting of the lower member 24 to emulate the resistance the user would experience when performing the procedure on a human patient.

As the lower member 24 is pivoted downward, the cam element 42 of the lower member is likewise pivoted (or rotated). Due to the shape of the outer cam surface 44, the distance between the cam surface and the pivot point (i.e., the pin 28) increases at the point at which the bottom end of the joint member 50 contacts the cam surface. This increase in distance linearly displaces the joint member 50 upward within the distal portion 34 of the recess 32 of the upper member 22 and, therefore, moves the lower magnetic element 70 closer to the upper magnetic element 68.

As the lower member 24 continues to be pivoted downward, the magnetic elements 68, 70 eventually forcefully attract each other. Because of this attraction, the magnetic elements 68, 70 tend to suddenly snap together, as shown in FIG. 7B, creating a subtle audible and tactile “pop” similar to that experienced when the radial head of a human patient pops back into place. This pop provides feedback to the healthcare professional that confirms that the reduction procedure has been successfully performed. At that point, the reduction procedure is complete and the model arm 14 has reached its final (extended) orientation shown in FIG. 6B in which the arm is nearly straight. The model arm 14 can then be restored to its initial orientation shown in FIG. 6A, and the process can be repeated. As the reduction procedure can be repeated by the healthcare professional as often as needed or desired, the individual can acquire skill in performing the procedure before ever having to perform it on a human being.

1-20. (canceled)

21. An apparatus comprising:
a joint that pivotally connects an upper member of a model arm and a lower member of a model arm; and
a feedback mechanism comprising first and second magnetic elements that are positioned so as to provide audible and tactile feedback when the joint is moved during performance of a reduction procedure;
wherein rotation of the joint caused by rotation of the lower member changes an angular orientation of the magnetic elements; and
wherein the magnetic elements repel each other in a first angular orientation and attract each other in a second angular orientation.

22. The apparatus of claim 21, wherein the feedback mechanism is configured to fit within a recess of a bottom end of the upper member.

23. The apparatus of claim 22, wherein the apparatus comprises a shaft for affixing the feedback mechanism at a first point to the upper member of a model arm and at a second point to the lower member of the model arm.

24. The apparatus of claim 23, wherein the magnetic elements of the feedback mechanism are mounted on the shaft, and wherein the second magnetic element can be linearly displaced along the shaft.

25. The apparatus of claim 21, wherein the first magnetic element is positioned within a proximal portion of an upper member recess and the second magnetic element is positioned within a joint member recess.

26. The apparatus of claim 21, wherein the magnetic elements are spaced at a distance at which they repel each other when the upper member and the lower member of the model arm are in an initial bent orientation associated with a bending of the joint.

27. The apparatus of claim 21, wherein the magnetic elements are moved closer together causing the magnetic elements to forcefully attract each other, when the lower member of the model arm is pivoted downward by a user via movement of the joint.

28. The apparatus of claim 23, wherein a top end of the lower member includes a cam element and wherein downward pivoting of the lower member causes an outer surface of the cam element to interface with a joint member of the joint.

29. The apparatus of claim 28, further comprising a member configured to provide initial resistance to downward pivoting of the lower member relative to the upper member, the member comprising a tab that extends from a bottom end of the upper member of the model arm.

30. The apparatus of claim 29, wherein the recess comprises a distal portion and a proximal portion, wherein the distal portion is cylindrical and is closer to the tab than the proximal portion.

31. The apparatus of claim 30, wherein the proximal portion comprises a frustrum-shaped void, wherein the frustrum-shaped void includes a base portion and a top portion, wherein the base portion is wider than the top portion.

32. The apparatus of claim 31, wherein the recess comprises a circular passage that is closer to the proximal portion, wherein the circular passage is configured to receive the shaft of the feedback mechanism.

33. The apparatus of claim 30, further comprising a cam element adjacent to the joint, such that downward pivoting of the lower member causes the cam element to displace the joint member and the second magnetic element upward within the distal portion of the upper member recess toward the first magnetic element.

34. A method for simulating a reduction procedure, comprising:
providing a model of a human arm, having an upper member and a lower member, and a feedback mechanism connected to the upper and lower members, wherein the feedback mechanism comprises first and second magnetic elements positioned in a first relative angular orientation at which the first and second magnetic elements repel each other;
providing a first force in response to a user pushing or pulling the lower member downward;
providing a second force in response to a user twisting the lower member; and
based on the first force and the second force, changing angular orientation of the first and second magnetic elements to a second relative angular orientation at which the first and second attract each other;
wherein magnetic attraction of the first and second magnetic elements generates an audible and tactile pop when the first force and second force are provided.

35. The method of claim 34, wherein providing the first and the second force causes the magnetic elements to move closer together until a critical distance is reached at which point the magnetic elements forcefully attract each other.

36. The method of claim 34, wherein the feedback mechanism is configured to fit within a recess of a bottom end of the upper member, and wherein the model of a human arm includes a joint, wherein the joint includes a joint member to which the lower member is pivotally mounted.

37. The method of claim 34 wherein the model arm comprises a shaft for affixing the feedback mechanism at a first point to the upper member of the model arm and at a second point to the lower member of the model arm, wherein the magnetic elements of the feedback mechanism are mounted on the shaft, and wherein the second magnetic element can be linearly displaced along the shaft.

38. The method of claim 36, wherein the magnetic elements are spaced at a distance at which they repel each other when the upper member and the lower member of the model arm are in an initial bent orientation associated with a bending of the joint.

39. The method of claim 36, wherein a top end of the lower member includes a cam element, and applying the first and second force to the lower member causes the cam element to displace the joint member and the second magnetic element upward within a distal portion of the upper member recess toward the first magnetic element.
